(19) United States
(12) Patent Application Publication
(10) Pub. No.: US 2009/0182566 A1
(43) Pub. Date: Jul. 16, 2009

(54) Automatic Library Referral System and Method

(76) Inventors: Kulvir Singh Bhogal, Fort Worth, TX (US); Travis M. Grigsby, Austin, TX (US); Robert Ross Peterson, Austin, TX (US); Lisa Anne Seacat, San Francisco, CA (US)

Correspondence Address: IBM CORPORATION (SS), C/O STREETS & STEELE, 13831 NORTHWEST FREEWAY, SUITE 355, HOUSTON, TX, 77040, US

(21) Appl. No.: 11/972,375

(22) Filed: Jan. 10, 2008

(51) Int. Cl. G06Q 30/00; G06F 17/00

(52) U.S. Cl. 705/1

(57) ABSTRACT

Online activity between a client computer and an online store is electronically monitored to determine that an item referenced in the online activity is a publication, such as a book or periodical. In response, an electronic library database is automatically queried to determine whether a physical or electronic copy of the publication is available from the library. The availability of the publication is communicated to a user of the client computer and the user is given an option to borrow the publication.

### BACKGROUND OF THE INVENTION

1. Field of the Invention

The present invention relates to systems and methods for augmenting online shopping.

2. Description of the Related Art

Online shopping is a process consumers use to purchase products or services over the Internet from an online store (sometimes also referred to as an e-shop, e-store, Internet shop, or virtual store). Shopping at an online store is analogous to shopping at a so-called “brick and mortar” store, which is a term coined in response to the burgeoning of online stores to refer to conventional stores where consumers shop in person at a physical location. To further the analogy between online stores and brick-and-mortar stores, the prevailing method of shopping online involves selectively placing items into a “virtual shopping cart,” with the option of selectively removing any of the items from the shopping cart prior to checkout. At checkout, the shopper is charged or scheduled to be charged for the items in the shopping cart, along with any associated shipping and handling charges. A number of shopping cart software systems are known and need not be discussed in detail here.

A large segment of online shopping is the online sale of books and other publications. Sites like www.amazon.com and www.barnesandnoble.com generate huge sales volumes, a large portion of which remains the online sale of publications. These sites offer user-friendly interfaces that provide a generous selection of titles, convenient search features for locating the titles, extensive item descriptions, and customer and editorial reviews to facilitate the online shopper in selecting and purchasing the publications. Due to the sales volumes generated online, stores like these also tend to offer competitive pricing, often offering substantial discounts from retail pricing. Due in part to the convenience, selection, and competitive pricing of online shopping, these sites have become the dominant source for obtaining books and other publications for many individuals and organizations of all sizes.

The convenience and relative cost savings of buying books online has increased sales volumes. One can surmise that, despite the relative per-item cost savings, the advent of online shopping has actually caused the total amount of money individuals and companies spend on publications to increase. A solution is therefore desired to offset or minimize these increased costs of obtaining publications. Minimizing these costs would be particularly desirable in the case of larger companies who regularly purchase books on behalf of their employees. A solution for minimizing the costs of obtaining publications might desirably work in tandem with online shopping, so that the online commerce sector continues to prosper, while easing the financial burden on individuals and organizations.

### SUMMARY OF THE INVENTION

In a first embodiment, a method comprises electronically monitoring online activity between a client computer and an online store, including examining a description of the item in response to the item being placed in an electronic shopping cart, to determine that an item referenced in the online activity is a publication. In response to identifying the referenced item is a publication, an electronic library database that tracks the inventory of a library is automatically queried to determine whether the publication is available from the library. Whether the copy of the publication is available from the library is communicated to the client computer. The availability may refer to the availability of a physical copy at a physical library location, or an electronic copy, such as may be available for downloading.

In a second embodiment, a computer program product comprising a computer usable medium includes computer usable program code for supplementing an online shopping session. The computer program product includes computer usable program code for electronically monitoring online activity between a client computer and an online store to determine that an item referenced in the online activity is a publication, computer usable program code for automatically querying an electronic library database in response to identifying the referenced item is a publication, to determine whether a physical copy of the publication is available from the library, and computer usable program code for communicating to the client computer whether the physical copy of the publication is available from the library.

A third embodiment involves a system, wherein an online store offers items for sale, including items that are publications. A client computer has a browser configured for selective communication with the online store over the Internet. A library has a physical location and an associated online, electronic library database configured for tracking the inventory of publications at the physical location. A software object residing on one or both of the client computer and a server of the online store is configured to monitor online activity between the client computer and the online store to determine that an item referenced in the online activity is a publication. In response to determining that the referenced item is a publication, the software object automatically queries the library database to determine whether a physical copy of the publication is available from the physical location of the library.

Other embodiments, aspects, and advantages of the invention will be apparent from the following description and the appended claims.

### BRIEF DESCRIPTION OF THE DRAWINGS

FIG. 1 is a flowchart summarizing a method according to one embodiment of the invention.

FIG. 2 is a schematic diagram of an online shopping system according to an embodiment of the invention.

FIG. 3 is a flowchart outlining a detailed method of online shopping according to an embodiment of the invention.

FIG. 4 is a schematic diagram of a computer system that may be configured for implementing an automatic library referral system according to an embodiment of the invention.

### DETAILED DESCRIPTION OF PREFERRED EMBODIMENTS

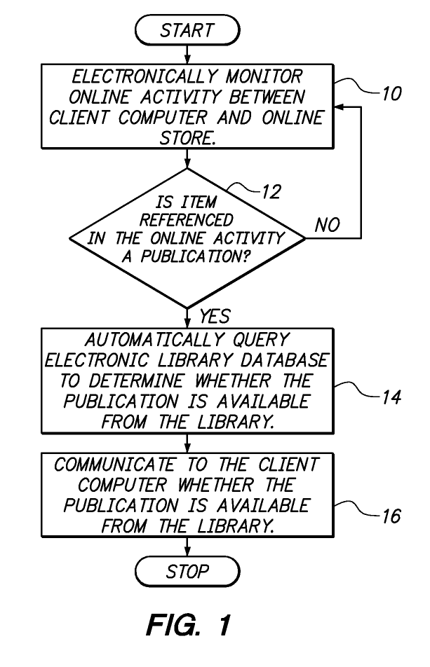

One embodiment of the present invention provides an automatic library referral system and method that can reduce costs to consumers by automatically providing an option to reserve and borrow publications otherwise selected for purchase from an online store. The term “publication” as used herein includes, by way of example, books, magazines, and other periodicals. FIG. 1 is a flowchart summarizing a method according to one embodiment of the invention. An online shopper (the “user”) conducts an online shopping session using a client computer in communication with an online store. In step 10, online activity between the client computer and the online store is electronically monitored to determine that an item referenced in the online activity is a publication. For example, the online activity may include the user searching for items to purchase from the online store, or placing one or more items in a virtual shopping cart. In step 12, the items referenced in the online activity are electronically examined to identify any items that are publications that may be available from a library. For example, the items or their descriptions may be examined by software residing on the client computer or on a server at the online store to determine whether the items referenced in the online activity include an ISBN (International Standard Book Number) identifying the item as a book, or an ISSN (International Standard Serial Number) identifying the item as a periodical. For any item identified as a publication (e.g., a book, periodical, or other publication), one or more library databases are automatically searched over the Internet in step 14 to determine if a physical copy of the publication is available from a physical location of a library. Alternatively, the library databases may be automatically searched over the Internet to determine if an electronic copy of the publication is available, such as for downloading over the Internet. The availability of the publication at a library may be communicated to the client computer in step 16. If a physical copy of the publication is available at one of the libraries, the user 30 may be prompted with the option to reserve the publication for borrowing from the library in lieu of purchasing the item from the online store. If an electronic copy of the publication is available, the user 30 may be prompted with the option to download the electronic copy or have the electronic copy shipped on a machine-readable medium (e.g. a computer-readable CD or DVD) to the user 30.

This approach is advantageous to the online shopper, and may also be beneficial to the online store, the libraries, or a third-party provider. The online shopper may save money by virtue of being presented with the option of borrowing rather than buying a particular publication. The libraries benefit by increased lending volume that may be used to justify increased library budgets. Although not required, the proprietor of the online store (i.e. the “online merchant”) or a third party provider may also participate in and benefit from the library referral system and method, such as by providing functionality from the online merchant's site or third-party provider's site for referring the user to libraries having the selected publications. In embodiments wherein the online merchant or a third-party provider participate, the user may pay the online merchant or third-party provider in exchange for foregoing the opportunity to sell the publication directly to the user 30. The online merchant or third-party provider may profit from any fees paid for referring the user to the participating library, and the online merchant may experience an overall increase in revenue by increasing the combined volume of actual sales in combination with such referral fees.

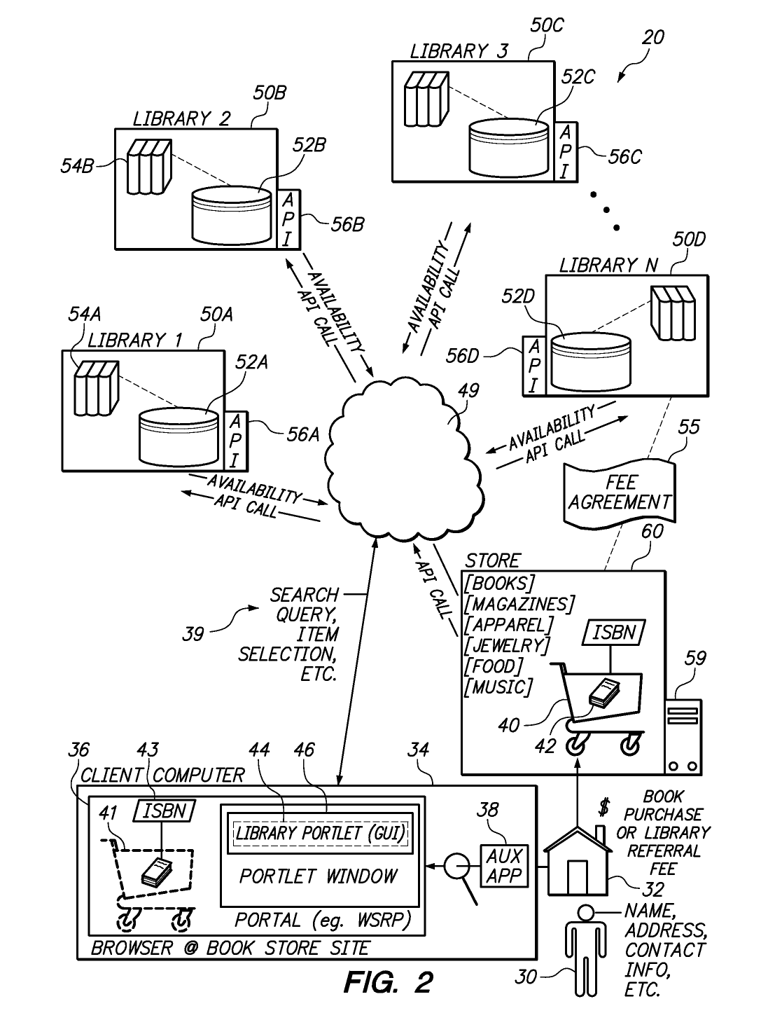

FIG. 2 is a schematic diagram of an online shopping system 20 according to an embodiment of the invention. The online shopping system 20 is just one example of a system that may be used to implement the method whose steps are summarized in FIG. 1. However, the online shopping system 20 of FIG. 2 is not the only system according to the invention that may be used to implement the method of FIG. 1. Any system capable of implementing the methods described herein may be used. Likewise, the method of FIG. 1 is not the only method according to the invention that may be implemented on the system 20 of FIG. 2. A user 30 has access to a client computer 34 from a “home” location 32. The client computer 34 is connected to the Internet 49, and includes a browser 36 that may be used to access the Internet 49 to browse an online store 60. The client computer 34 may be, for example, a personal computer (PC), a laptop computer, or a handheld device such as a PDA with wireless Internet access. The home location 32 may be, for example, the user's home, the user's office, or any other remote location at which the user 30 may use the client computer 34. For instance, the user 30 may browse the online store 60 while the user 30 is physically present at a coffee shop, in which case the client computer 34 may be a laptop computer connected to the Internet 49 using a wireless connection provided at the coffee shop.

A virtual shopping cart 40 (“cart”) is provided. The shopping cart is an interface governed by software that allows the user 30 to select items for potential purchase, review the selected items prior to purchase, optionally modify or add the items for potential purchase, and finally purchase the selected items in the shopping cart 40. A variety of shopping cart software models are known in the art, and are briefly discussed here. In one version, the shopping cart 40 may be licensed software downloaded and then installed on a server 59 of the online store 60. Alternatively, the cart 40 may be a hosted service provided on an application service provider (ASP) software model. The cart 40 in this embodiment resides on the server 59 at the online store 60, and a shopping cart interface 41 at the client computer 34 is a graphical interface on the client computer 34 for accessing and viewing the contents of the shopping cart 40. This shopping cart interface 41 may have predefined templates that the user 30 can view and that the online store 60 may choose from to customize the “look and feel” of the shopping cart 40 to the user 30.

An auxiliary software object or application 38, optionally installed on the client computer 34 in this embodiment, includes executable program code usable by the client computer 34 for monitoring online activity between the client computer 34 and the online store 60. In an alternate embodiment (not shown), program code for monitoring online activity between the client computer 34 and the online store 60 may instead reside on another computer, such as the server 59 of the online store 60, or even another, third-party or intermediary computer residing elsewhere on the Internet 49. The auxiliary application 38 may be configured, for example, to examine item search queries or the results of item search queries (generally indicated at 39) that are placed at the online store 60 using the client computer 34. Alternatively, the auxiliary application 38 may be configured to examine the contents of the shopping cart 40. Online activity, such as search queries for items or the placement of items in the shopping cart 40, is monitored to detect references to publications. For example, the presence of an ISBN or ISSN in the search query, search query results, or item description of an item in the shopping cart 40 is an indication that the item is a publication of the type that might be available in a physical format available from a library. Alternatively, the publication might be available in an electronic format. The auxiliary application 38 may access the item descriptions for the items in the cart 40, looking for information that would identify a particular item as being a publication such as a book, magazine, or an audiovisual medium (e.g. a CD or DVD), as opposed to some other item not typically available for borrowing at a library, like apparel, jewelry, or food. By way of example, a book 42 having a uniquely associated ISBN 43 is shown in the shopping cart 40. Because ISBN numbers are known to be identifiers for publications such as books, the auxiliary application 38 may include computer usable program code for detecting and interpreting the presence of the ISBN 43 as being indicative of a book or other publication.

Any number of libraries may be included in the system 20. Four libraries 50A, 50B, 50C, and 50D are shown by way of example, labeled from “Library 1” to “Library N.” Each library 50A-D includes a respective library database 52A-D (e.g. an online, electronic library catalog) uniquely associated with the specific library 50 and remotely accessible by authorized devices over the Internet 49. For example, the database 52A associated with the library 50A may track the dynamic inventory of Library 1 that includes books and other publications 54A available for borrowing from Library 1. A variety of ways are available for interfacing with the library databases 52A-D. In this embodiment, each library database 52A-D includes a respective application programming interface (“API”) 56A-D for interfacing with the library databases 52A-D. An API is a source code interface that an application provides to support requests for services to be made of it by computer programs. Based on the API calls (i.e., a request to identify availability of the publication), the online store 60 and/or the client computer can be informed if a physical or electronic copy of a book having the same ISBN as the book 42 is available for borrowing from any of the libraries 50A-D. The user 30 may implicitly or explicitly indicate a desired location, such as by inputting a preference to search libraries within a certain radius of the home location 32. The availability of the book 42 can then be further specified with regard to its distance from the home location 32. Each library 50A-D may use a portal based web technology such as Web Services for Remote Portals (WSRP) to provide a graphical user interface (GUI) in the form of a library portlet 44 for display at a portlet window 46. The user 30 may use the library portlet 44 to reserve a publication, such as the book 42 for borrowing. The reservation may be established by associating information about the user 30, such as the name, address, or contact information of the user 30, with the book 42. The user 30 or an agent of the user 30 (e.g. a family member or friend authorized on the user's library membership) may later present this information to the library where the copy of the book 42 is reserved in order to borrow the book 42 from the library.

The library 50D is an example of a “participating” library having a pre-established relationship with the online merchant and/or the user 30 to provide the option of borrowing publications from the library 50D instead of (or in addition to) purchasing them from the online store 60. The established relationship may be characterized, at least in part, by the existence of a fee agreement 55 or other contract between the participating library 50D and the online store 60 (or the user 30). The fee agreement 55 sets forth terms for providing the option of borrowing items from one of the libraries in lieu of (or in addition to) purchasing them from the online store 60. The optional fee agreement 55 may specify, for example, that the library 50D or the user 30 pay a referral fee in response to the user 30 borrowing the book 42 from the library 50D instead of purchasing the book 42 from the online store 60. The other libraries 50A-C may be “passive” libraries having a publicly-accessible online interface for viewing (possibly for free) the respective databases 52A-52C, without a formal agreement in place. The databases 52A-D of all of the libraries 50A-D are accessible over the Internet 49 by the online store 60 and/or the client computer.

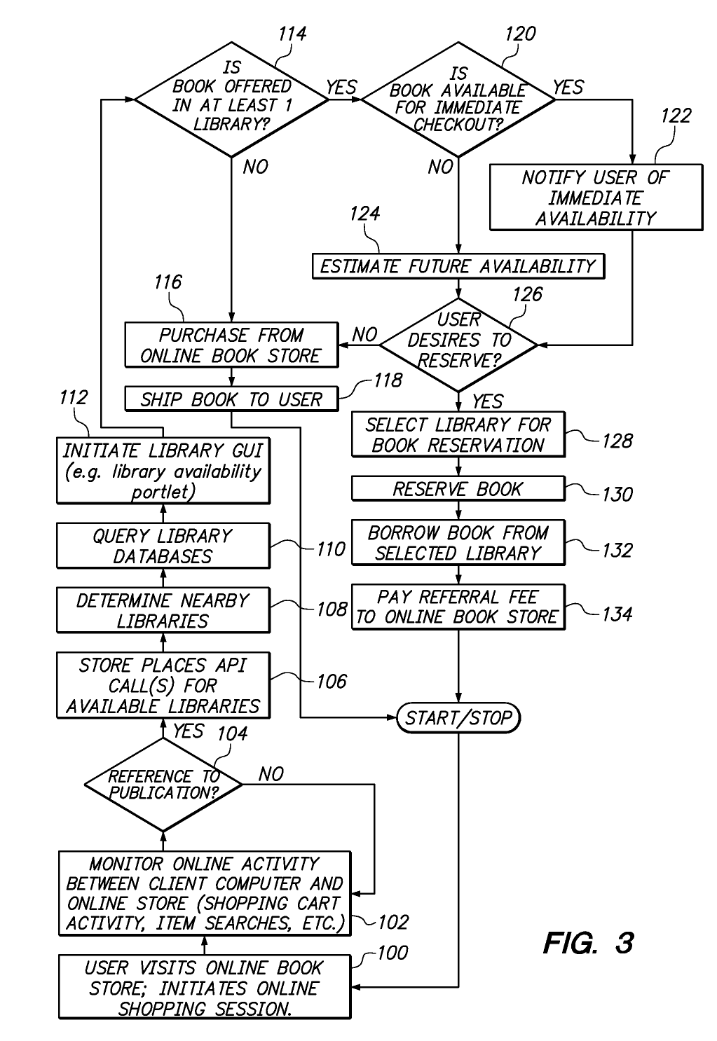

Having set forth an example of the system 20 that enables the use of an automatic library referral system, FIG. 3 presents a flowchart outlining a detailed method of online shopping according to an embodiment of the invention. This method may be implemented on the system 20 of FIG. 2, and one skilled in the art may therefore draw parallels between the discussion of the flowchart of FIG. 3 and the discussion of the use of the system 20 of FIG. 2. However, it should be recognized that the method of FIG. 3 is not strictly limited to being implemented on the system 20 of FIG. 2, and the system 20 of FIG. 2, likewise, is not limited to performing the method of FIG. 3. One skilled in the art will further appreciate that the system 20 of FIG. 2 and the method of FIG. 3 are not the only embodiments that the invention provides.

Referring to FIG. 3, a user visits an online store and initiates an online shopping session in step 100. For example, the user may browse to the Web address of the online store and log-in with a username and password. The online store may have previously stored information about the user, such as from a previous online shopping session. The user information may include, for example, the name of the user, billing and shipping address for the user, and payment information such as bank or credit card information. Alternatively, this user information may be entered by the user at some point during the online shopping session initiated in step 100. The store may be any online store that offers books and other publications for sale, and is also assumed to sell items other than publications. The user may shop for items such as by browsing or searching for items, selecting items for purchase, and placing the selected items in the cart. This and other online activity may be monitored in step 102. Step 104 determines whether the monitored online activity contains reference to a publication. For example, the online activity may contain reference to an ISBN for a book or an ISSN for a periodical. Alternatively, a database of book titles and periodical titles may be referenced in addition to or in lieu of an ISBN or ISSN to determine whether the monitored online activity references a book title.

If it is determined in step 104 that the online activity references a publication, then the online store places API calls to available libraries in step 106 (either publicly accessible libraries or participating libraries, as discussed above in connection with FIG. 2). Then, step 108 optionally determines which libraries satisfy distance criteria that may have been previously specified by the user. For example, libraries that are within a user-specified radius from the user's home location may be selected in step 108. The user may change or omit the distance criteria to locate more libraries that offer the referenced publication. Any number of libraries will be queried in step 110 to determine if the referenced publication is available from one or more of the libraries. Steps 110 and 108 may be performed in conjunction with one another, or in an alternate order, to determine which libraries offer the referenced publication and then to select which of those libraries is within a convenient distance from the user. For example, step 110 may be performed prior to step 108, in that all available libraries may first be queried according to step 110, and a resulting list of libraries offering the desired publication may be subsequently narrowed down to those that also satisfy the distance criteria according to step 108.

In step 112, a library graphical user interface (GUI) may be initiated. The GUI may be provided by one or more selected library and downloaded over the Internet to the client computer on which the user is conducting the online shopping session. The GUI may allow the user to view the availability information for the publication referenced in step 104. The availability information may include information about which libraries own a physical (or electronic) copy of the referenced publication and when that copy will be available for the user to borrow. Whether or not the publication is available from at least one of the libraries is determined according to step 114. Step 114 assumes, by way of example, that the referenced publication is a book. If the book is not available in at least one library, then the user purchases the book according to step 116. To purchase the book, the user may simply leave the book in the shopping cart, and the book will be purchased along with any other items in the shopping cart during a checkout process known in the art. The book may then be shipped to the user, along with the other purchased items, according to step 118.

If the book is available from at least one library in step 114, however, then step 120 is followed to determine when the book is available to the user. If the book is available for immediate checkout, the user may be notified of the immediate availability in step 122. For example, the availability of the book may be displayed by the GUI on the client computer. If the book is offered by at least one library in step 114 but is not available for immediate checkout or borrowing in step 120, then the GUI may instead estimate future availability of the book in step 124. For example, the future availability of the book may be estimated according to the date the book is scheduled to be returned to the library by the current borrower, i.e. the “due date.”

Whether the book is immediately available (step 122) or available at a future date (step 124), the user is given the option to reserve the book in step 126. For example, the user may consider whether the present or future availability, and the location of the library from which the book is available, will be convenient to the user for borrowing the book. If not, the user may purchase the book from the online store according to step 116. However, if the user desires to reserve the book, then the user selects the location (assuming the book is available from more than one library) from which to borrow the book in step 128. If the user did not previously have a membership with the selected library location, the GUI may provide the option to become a member during the online shopping session.

The GUI may be used to reserve the book in step 130. To reserve the book, information about the user (e.g. name, address, phone number, social security number, or other identifying information) may be associated in an electronic reservation database with the requested publication. An existing electronic reservation database may be accessed over the Internet. The reservation database may be a portion of the same general library database that dynamically tracks the publications available from the library. The user may then borrow the book in step 132 from the library selected in step 128. The user may borrow the book in a conventional manner, such as by visiting the library in-person, presenting credentials evidencing the user information used to reserve the book in step 130, and borrowing the book for a period of time set forth in terms of the user's library membership. Alternatively, the library may ship the book to the user for a “shipping and handling” fee. In step 134, an optional referral fee is paid to the online store, which may at least partially offset the opportunity to have sold the book to the user from the online store. Due to market forces, online stores often operate at high-volumes and correspondingly low profit margins. Thus, a referral fee that may seem reasonable or even inexpensive to the user may, on average, generate a profit-per-book that is comparable to the profit the online store would otherwise make by selling the book directly to the user. Thus, from the perspective of both the online store and the user, the payment of the referral fee may be an attractive alternative to purchasing the book. Furthermore, the online store may collect information identifying the publications that were requested in a region near each library and use that information to encourage the library to purchase those same publications.

According to the above description, the invention may include software elements. More generally, the invention can take the form of a computer program product comprising a computer usable medium including computer usable program code for use by or in connection with a computer or any instruction execution system. For the purposes of this description, a computer-usable or computer readable medium can be any apparatus that can contain or store the program for use by or in connection with the instruction execution system, apparatus or device. The medium can be, for example, an electronic, magnetic, optical, electromagnetic, infrared, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), and DVD.

A data processing system suitable for storing and/or executing program code typically includes at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution.

Input/output (I/O) devices such as keyboards, displays, or pointing devices can be coupled to the system, either directly or through intervening I/O controllers. Network adapters may also be used to allow the data processing system to couple to other data processing systems or remote printers or storage devices, such as through intervening private or public networks. Modems, cable modems, Ethernet cards, and wireless network adapters are examples of network adapters.

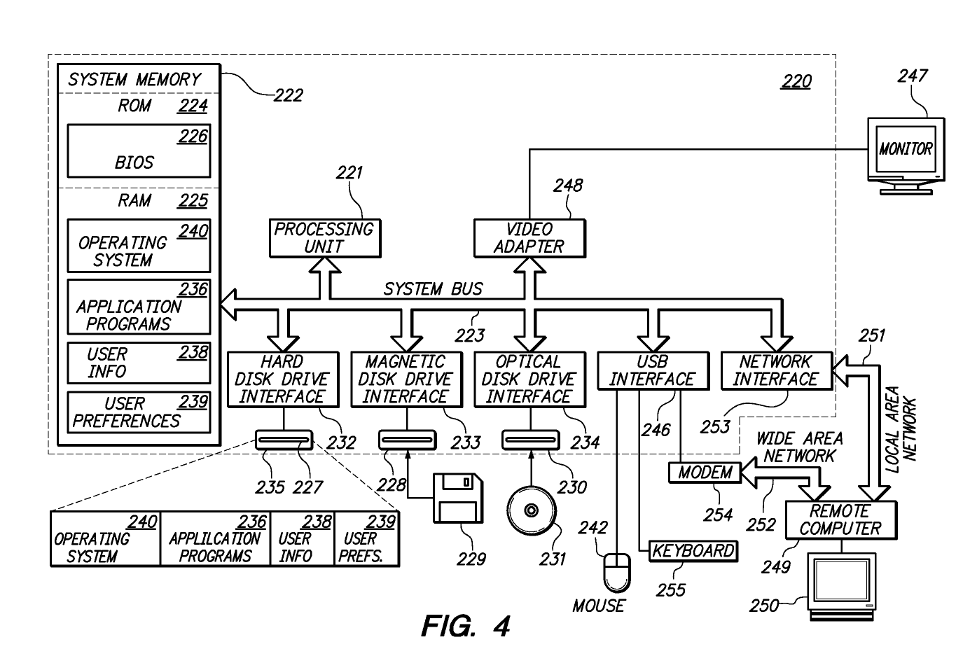

To illustrate, FIG. 4 is a schematic diagram of a computer system generally indicated at 220 that may be configured for implementing an automatic library referral system according to an embodiment of the invention. The computer system 220 may be a general-purpose computing device in the form of a conventional computer system, such as the client computer 34, either alone or in combination with other processing systems such as the server 59 of FIG. 2. Generally, computer system 220 includes a processing unit 221, a system memory 222, and a system bus 223 that couples various system components, including the system memory 222 to processing unit 221. System bus 223 may be any of several types of bus structures including a memory bus or memory controller, a peripheral bus, and a local bus using any of a variety of bus architectures. The system memory includes a read only memory (ROM) 224 and random access memory (RAM) 225. A basic input/output system (BIOS) 226 is stored in ROM 224, containing the basic routines that help to transfer information between elements within computer system 220, such as during start-up.

Computer system 220 further includes a hard disk drive 235 for reading from and writing to a hard disk 227, a magnetic disk drive 228 for reading from or writing to a removable magnetic disk 229, and an optical disk drive 230 for reading from or writing to a removable optical disk 231 such as a CD-R, CD-RW, DV-R, or DV-RW. Hard disk drive 235, magnetic disk drive 228, and optical disk drive 230 are connected to system bus 223 by a hard disk drive interface 232, a magnetic disk drive interface 233, and an optical disk drive interface 234, respectively. Although the exemplary environment described herein employs hard disk 227, removable magnetic disk 229, and removable optical disk 231, it should be appreciated by those skilled in the art that other types of computer readable media which can store data that is accessible by a computer, such as magnetic cassettes, flash memory cards, digital video disks, Bernoulli cartridges, RAMs, ROMs, USB Drives, and the like, may also be used in the exemplary operating environment. The drives and their associated computer readable media provide nonvolatile storage of computer-executable instructions, data structures, program modules, and other data for computer system 220. For example, the operating system 240 and application programs 236 may be stored in the RAM 225 and/or hard disk 227 of the computer system 220. The application programs 236 may include, for example, the auxiliary application 38 and/or the library portlet 44 of FIG. 2.

A user may enter commands and information into computer system 220 through input devices, such as a keyboard 255 and a mouse 242. Other input devices (not shown) may include a microphone, joystick, game pad, touch pad, satellite dish, scanner, or the like. These and other input devices are often connected to processing unit 222 through a USB (universal serial bus) 246 that is coupled to the system bus 223, but may be connected by other interfaces, such as a serial port interface, a parallel port, game port, or the like. A display device 247 may also be connected to system bus 223 via an interface, such as a video adapter 248. In addition to the monitor, personal computers typically include other peripheral output devices (not shown), such as speakers and printers.

The computer system 220 may operate in a networked environment using logical connections to one or more remote computers 249. Remote computer 249 may be another personal computer, a server (e.g., the server 59 of FIG. 2 or a library server), another client computer, a router, a network PC, a peer device, a mainframe, a personal digital assistant, an Internet-connected mobile telephone or other common network node. While a remote computer 249 typically includes many or all of the elements described above relative to the computer system 220, only a memory storage device 250 has been illustrated in FIG. 4. The logical connections depicted in the figure include a local area network (LAN) 251 and a wide area network (WAN) 252. Such networking environments are commonplace in offices, enterprise-wide computer networks, intranets, and the Internet.

When used in a LAN networking environment, the computer system 220 is often connected to the local area network 251 through a network interface or adapter 253. When used in a WAN networking environment, the computer system 220 typically includes a modem 254 or other means for establishing high-speed communications over WAN 252, such as the Internet. Modem 254, which may be internal or external, is connected to system bus 223 via USB interface 246. In a networked environment, program modules depicted relative to computer system 220, or portions thereof, may be stored in the remote memory storage device 250. It will be appreciated that the network connections shown are exemplary and other means of establishing a communications link between the computers may be used.

Program modules may be stored on hard disk 227, optical disk 231, ROM 224, RAM 225, or even magnetic disk 229. The program modules may include portions of an operating system 240, application programs 236, or the like. A user info database 238 may be included, which may contain user information used in connection with browsing and purchasing publications from an online store and for reserving and borrowing publications from a library. A user preferences database 239 may also be included, which may contain user-specified preferences such as distance criteria used for selecting libraries.

Aspects of the present invention may be implemented in the form of application program 236. Application program 236 may be informed by or otherwise associated with user info database 238 and/or user preferences database 239. The application program 236 generally comprises computer-executable instructions for implementing an automatic library referral method.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
electronically monitoring online activity between a client computer and an online store, including examining a description of the item in response to the item being placed in an electronic shopping cart, to determine that an item referenced in the online activity is a publication;
in response to identifying the referenced item is a publication, automatically querying an electronic library database that tracks the inventory of a library to determine whether the publication is available from the library; and
communicating to the client computer whether the publication is available from the library.

2. The method of claim 1, wherein the step of electronically monitoring online activity between a client computer and an online store further comprises electronically monitoring a search query or the results of the search query placed at the online store from the client computer.

3. The method of claim 1, wherein the step of identifying a referenced item is a publication comprises identifying that an ISBN or an ISSN is associated with a description of the referenced item.

4. The method of claim 3, wherein the step of querying an electronic library database comprises searching the library database for publications associated with the ISBN or the ISSN.

5. The method of claim 1, further comprising grouping items available for purchase through the online store into at least one group of items that are publications and at least one group of items that are not publications, wherein the step of monitoring the online activity to determine that an item is a publication comprises identifying that the referenced item is included in the at least one group of items that are publications.

6. The method of claim 1, further comprising:
obtaining distance criteria from a user of the client computer; and
automatically determining whether a physical location of the library satisfies the distance criteria.

7. The method of claim 1, further comprising:
communicating user information from the client computer to a system of the library; and
reserving the publication for borrowing by electronically associating the user information with the referenced item in the library database.

8. The method of claim 7, further comprising:
incurring a fee from a user or the library to the online store in response to the association of the user information with the referenced item.

9. The method of claim 8, wherein the user information includes one or more of the group consisting of a name, billing address, contact information, and payment information associated with the user.

10. The method of claim 7, further comprising:
obtaining the user information from an electronic shopping cart containing the referenced item.

11. A system, comprising:
an online store offering items for sale, including items that are publications;
a client computer having a browser configured for selective communication with the online store over the Internet;
a library system having an associated online, electronic library database configured for tracking the inventory of publications available from the library; and
a software object residing on one or both of the client computer and a server of the online store, the software object configured to monitor online activity between the client computer and the online store to determine that an item referenced in the online activity is a publication and, in response to determining that the referenced item is a publication, automatically querying the library database to determine whether the publication is available from the library.

12. A computer program product comprising a computer usable medium including computer usable program code for supplementing an online shopping session, the computer program product including:
computer usable program code for electronically monitoring online activity between a client computer and an online store to determine that an item referenced in the online activity is a publication;
computer usable program code for automatically querying an electronic library database in response to identifying the referenced item is a publication, to determine whether the publication is available from the library; and
computer usable program code for communicating to the client computer whether the publication is available from the library.

13. The computer program product of claim 12, wherein the computer usable program code for automatically querying the electronic library database is executable by the client computer or by a server of the online store.

14. The computer program product of claim 12, wherein the computer usable program code for electronically monitoring online activity between the client computer and the online store comprises computer usable program code for examining a description of the item in response to the item being placed in an electronic shopping cart.

15. The computer program product of claim 12, wherein the computer usable program code for electronically monitoring the online communication between the client computer and the online store comprises computer usable program code for electronically monitoring a search query or the results of the search query placed at the online store from the client computer.

16. The computer program product of claim 12, wherein the computer usable program code for identifying the referenced item as a publication comprises computer usable program code for identifying that a description of the referenced item contains an ISBN or an ISSN.

17. The computer program product of claim 16, wherein the computer usable program code for querying the electronic library database comprises computer usable program code for searching the library database for publications associated with the ISBN or the ISSN.

18. The computer program product of claim 12, further comprising:
computer usable program code for obtaining distance criteria from a user of the client computer; and
computer usable program code for automatically determining whether a physical location of the library satisfies the distance criteria.

19. The computer program product of claim 16, further comprising:
computer usable program code for communicating user information from the client computer to the library; and
computer usable program code for reserving the publication for borrowing by electronically associating the user information with the referenced item in the library database.
